(19) United States
(12) Patent Application Publication
(10) Pub. No.: US 2003/0137148 A1
(43) Pub. Date: Jul. 24, 2003

(54) Fluid quick connector with non-rotation conduit engaging ribs

(76) Inventors: Michael J. Andre, Lincoln Park, MI (US); George Szabo, Ortonville, MI (US)

Correspondence Address: ATTN: William M. Hanlon, Jr., YOUNG & BASILE, P.C., SUITE 624, 3001 WEST BIG BEAVER ROAD, TROY, MI, 48084-3107, US

(21) Appl. No.: 10/389,066

(22) Filed: Mar. 14, 2003

Related U.S. Application Data
(62) Division of application No. 09/748,959, filed on Dec. 27, 2000.
(63) Continuation-in-part of application No. 09/748,959, filed on Dec. 27, 2000.

(51) Int. Cl. F16L 37/00

(52) U.S. Cl. 285/305; 285/319

(57) ABSTRACT

A fluid connector includes at least one barb adjacent one end for expanding a flexible conduit thereover. At least one axially and radially extending, non-annular rib is carried on the connector adjacent to the barb. The rib alters the end shape of the flexible conduit into raised and lowered portions which resist rotation of the flexible conduit relative to the connector. The ribs may be employed on any fluid connector, including an adaptor between two fluid conduits, or on a one or two piece fluid quick connector coupling an end form to a flexible conduit.

### CROSS REFERENCE TO CO-PENDING APPLICATION

This application is a division and a continuation-in-part of co-pending, U.S. patent application, Ser. No. 09/748,959, filed Dec. 21, 2000, the contents of which are incorporated herein in its entirety.

### BACKGROUND

The present invention relates, in general, to fluid quick connector assemblies which couple male and female connector components and, more specifically, to fluid quick connectors having a retainer which locks the male connector component in the female connector component.

Snap-fit or quick connectors are employed in a wide range of applications, particularly, for joining fluid carrying conduits in automotive and industrial application. In a typical quick connector with an axially displaceable retainer, the retainer is fixedly mounted within a bore in a housing of a female connector component or element. The retainer has a plurality of radially and angularly extending legs which extend inwardly toward the axial center line of the bore in the housing. A tube or male fitting to be sealingly mounted in the bore in the female component includes a radially upset portion or flange which abuts an inner peripheral surface of the retainer legs. Seal and spacer members as well as a bearing or top hat are typically mounted in the bore ahead of the retainer to form a seal between the housing and the male fitting when the male fitting is lockingly engaged with the retainer legs.

Radially displaceable retainers in which the retainer is radially displaceable through aligned bores or apertures formed transversely to the main through bores in the female component or housing are also known. The radially displaceable retainer is typically provided with a pair of depending legs which are sized and positioned to slip behind the radially upset portion or flange on the male conduit only when the male connector or conduit is fully seated in the bore in the female connector. This ensures a positive locking engagement of the conduit with the female connector as well as providing an indication that the conduit is fully seated since the radially displaceable retainer can be fully inserted into the female connector only when the conduit has been fully inserted into the bore in the female connector.

Regardless of the type of retainer, the female housing or component portion of a fluid connector typically includes an elongated stem having one or more annular barbs spaced from a first end. The barbs provide engagement with a hose or conduit which is forced over the barbs to connect the female housing with one end of the conduit.

The barbs are typically formed as a smooth conical surface extending from a first smaller diameter to a large diameter end. The smooth conical surface of each barb enables the end of the conduit to expand in diameter over the barbs as the barb end of the connector and the conduit are urged together. In a final insertion position, the end of the conduit assumes the shape of the barbed end of the connector with alternating enlarged and reduced diameter portions in secure contact with the stem portion of the connector to resist separation of the conduit and connector.

However, the smooth conical surface of the barbs provides a smooth surface which allows rotation of the flexible conduit about the axis of the stem of the housing. Such rotation can create leakage paths between the conduit and the housing or lead to eventual separate of the conduit from the housing.

Various attempts have been made to provide a non-rotatable connection between an expanded flexible conduit and barbs on the end of the a connector body. Several such prior art designs use an external crimping collar which is crimped about the expanded end of the conduit to forcibly engage the conduit between the alternating inner and outer diameter ends on the stem of a housing formed by a plurality of axially spaced barbs.

Another attempt shown in U.S. Pat. No. 5,853,202 provides rotation resisting means on one of the barbs of the housing stem. The rotation resisting means takes a number of forms including a plurality of circumferentially spaced depressions on the conical land of the barb, a plurality of recesses also formed in the conical land of the barb, or a plurality of radially outward extending, circumferentially spaced projections formed on the conical land of the barb.

A crimping collar is also disclosed in U.S. Pat. No. 5,853,202 for crimping over the joined conduit end and barbed end of the housing. Without the use of the crimping collar, it is believed that the end of the conduit will not sufficiently deform into the depressions or recesses formed in one of the barbs to create sufficient non-rotation resistance. The embodiment using a plurality of radially extending projections on the barb itself increases the insertion force required to expand the conduit over the barb thereby making it more difficult to initially secure the conduit to the stem of a housing.

Thus, it would be desirable to provide a fluid quick connector which overcomes the problems of previously devised quick connectors with respect to secure leak resistant engagement between the hose or conduit and the connector housing and without a significant increase in insertion force to mount the hose to the connector housing.

### SUMMARY OF THE INVENTION

The present invention is a fluid connector having a housing or body with a bore extending between opposed ends. One end of the connector housing or body is formed with at least one radially outward extending, non-annular, projection or rib which forcibly engages the inner surface of a flexible conduit mounted thereover. The rib(s) prevent rotation between the flexible conduit and the housing which could lead to the formation of leaks between the flexible conduit and the housing and/or separation of the flexible conduit from the housing.

The at least one rib can also be a plurality of circumferentially spaced ribs.

The ribs of the present invention are employable on different fluid connector bodies including a tubular adaptor mountable between two flexible conduits wherein ribs and the barbs may be formed at opposite ends or on only one end of the adapter body, with the other end of the adaptor body optionally receiving a fluid quick connector. The ribs may also be employed on fluid quick connectors having a housing receiving a tubular endform in one end and a flexible conduit at another. The fluid quick connector housing may be formed as one piece or of multiple pieces.

The ribs of the present invention uniquely prevent rotation between a flexible conduit mountable on a fluid quick connector and the connector itself. This minimizes the potential for the development of leaks between the conduit and the connector. The ribs may be easily employed on a number of different fluid connector bodies without significant modification to other elements of the fluid connector.

### BRIEF DESCRIPTION OF THE DRAWING

The various features, advantages and other uses of the present invention will become more apparent by referring to the following detailed discussion and drawing in which:

FIG. 1 is a perspective view of an assembled rotatable quick connector according to one aspect of the present invention;

FIG. 2 is an exploded, perspective view of the rotatable quick connector shown in FIG. 1;

FIG. 3 is a longitudinal, cross-sectional, perspective view of the assembled rotatable quick connector shown in FIG. 1;

FIG. 4 is a perspective view of an assembled rotatable quick connector according to another aspect of the present invention;

FIG. 5 is an exploded, perspective view of the rotatable quick connector shown in FIG. 4;

FIG. 6 is a longitudinal, cross-sectional, perspective view of the rotatable quick connector shown in FIG. 4;

FIG. 7 is a perspective view of a rotatable quick connector according to another aspect of the present invention shown in an assembled state;

FIG. 8 is an exploded perspective view of the rotatable quick connector shown in FIG. 7;

FIG. 9 is a longitudinal, cross-sectional, perspective view of the assembled quick connector shown in FIG. 7;

FIG. 10 is a perspective view of the rotatable quick connector of FIG. 7 shown in a shipping state;

FIG. 11 is a bottom view of the assembled quick connector of FIG. 7;

FIG. 12 is a partially cross-sectioned, end view of the assembled quick connector of FIG. 7;

FIG. 13 is a longitudinal cross-sectional view through an adaptor employing non-rotation ribs according to another aspect of the present invention;

FIG. 14 is a cross-sectional view generally taken along line 14-14 in FIG. 13; and

FIG. 15 is a longitudinal cross-section, perspective view of a fluid quick connector employing the non-rotation ribs according to another aspect of the present invention.

### DETAILED DESCRIPTION

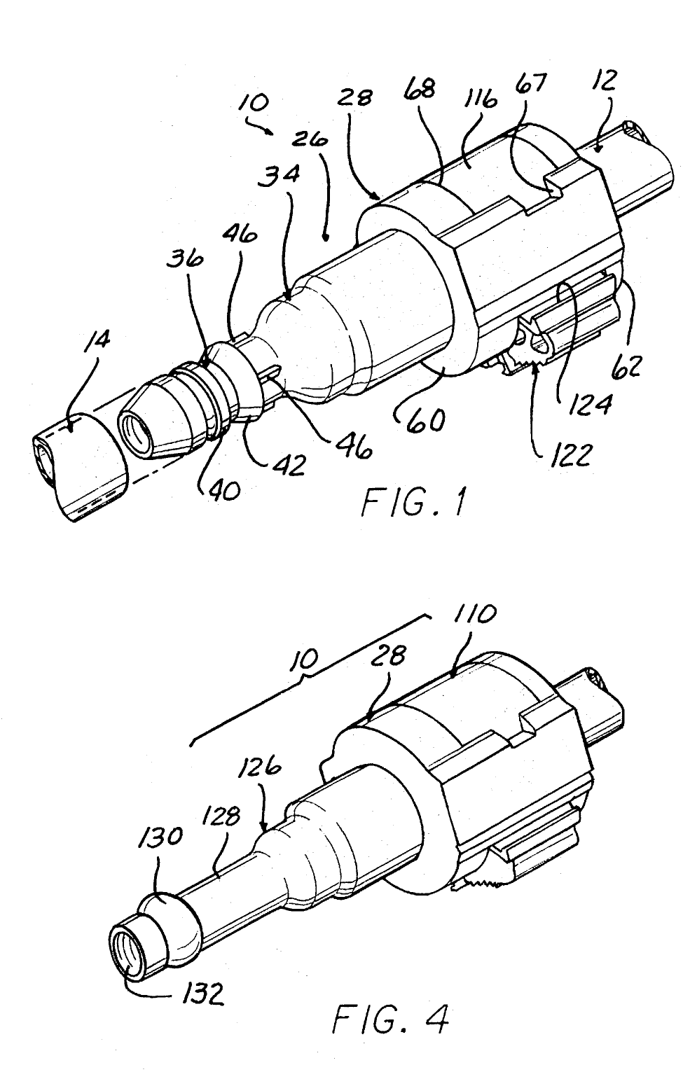

Referring now to FIGS. 1-3, there is depicted one aspect of a quick connector 10 constructed in accordance with the teachings of the present invention. As is conventional, the quick connector 10 is adapted for sealingly and lockingly, yet removably interconnecting first and second conduits 12 and 14 in a fluid tight, leak proof, sealed connection by a snap-together connection.

The first conduit 12 is typically formed of metal and has an endform with a tapered end or tip 18 at one end, a through bore 20 and an enlarged annular flange 22 spaced from the tip end 18.

The second conduit 14 is typically formed of a flexible material, such as a polymer, i.e., nylon. The conduit 14 has an internal bore which communicates with a bore extending through the quick connector 10, as described hereafter, and the bore 20 in the first conduit 12.

The quick connector 10 includes a first housing 26 and a second housing 28 which are adapted to be axially connected to provide an axially extending throughbore between opposite ends.

The first housing 26 is formed of a one piece body, preferably of a high strength plastic, and has a stepped exterior surface formed of a raised annular flange 30 at one end, an enlarged diameter portion 32 extending from the flange 30, an intermediate, smaller diameter portion 34 and a necked-down portion or stem 36 which extends from the intermediate diameter portion 34 to an annular flange 38 formed at another end of the first housing 26. At least one and, preferably, a plurality of longitudinally spaced barbs or projections 40 and 42 are formed along the exterior of the stem 36 for secure engagement with the second conduit 14, which is slidably urged thereover.

According to one aspect of the present invention, at least one or a plurality of radially extending ribs 46, with four being used as an example only, are formed on the stem 36 between the barb 42 and the intermediate diameter portion 34 of the first housing 26. When the end portion of the first conduit 14 shrinks back to its nominal diameter after passing over the barb 42, or at least the end portion disposed between the barb 42 and the intermediate diameter portion 34 of the first housing 26, the rib(s) 46 will engage the interior surface of the second conduit 14 and assist in preventing relative rotation between the first housing 26 and the second conduit 14 by forming alternating ridges and recesses in the end portions of the conduit 14.

An endform interface member 50 in the form of a cap having a conical end portion which smoothly merges with an annular end portion is slidably mounted over the end of the stem 36 of the first housing 26. A seal member 52, typically in the form of an O-ring is interposed between the annular end portion of the cap 50 and the barb 40. The structure and operation of the interface endform or cap 50 are described in greater detail in U.S. patent application Ser. No. 09/309,979, which is assigned to the assignee of the present invention. The entire contents of this co-pending application are incorporated herein by reference.

According to a unique aspect of the present invention, the cap 50 is provided with an interior annular recess 51 spaced a distance from the end face of the annular end portion of the cap 50. The recess 51 is sized to engage the annular flange 38 on the end of the nose portion 36 of the first housing 26 to aid in maintaining the cap 50 on the first housing 26. The use of this snap-on feature for the cap 50 is preferably employed with first housings 26 formed of plastic.

The second housing 28 is preferably formed of a one piece, unitary body of a high strength plastic, such as nylon, for example. The second housing 28 includes first and second annular ring members 60 and 62, respectively. The first and second ring members 60 and 62 are spaced apart and interconnected by a pair of side legs 64 and 66 which extend between peripheral edges of the first and second ring members 60 and 62. Notches 67 are formed along one edge of each of the side legs 64 and 66 for receiving an interconnecting projection in a retainer, as described hereafter. Preferably, the side legs 64 and 66 are parallel to each other and, in conjunction with the first and second ring members 60 and 62, define transversely opening apertures 68 and 70. The transversely extending apertures 68 and 70 communicate with a through bore which extends longitudinally through the second housing 28 from a first bore within the first ring member 60 to a second bore in the second ring member 62.

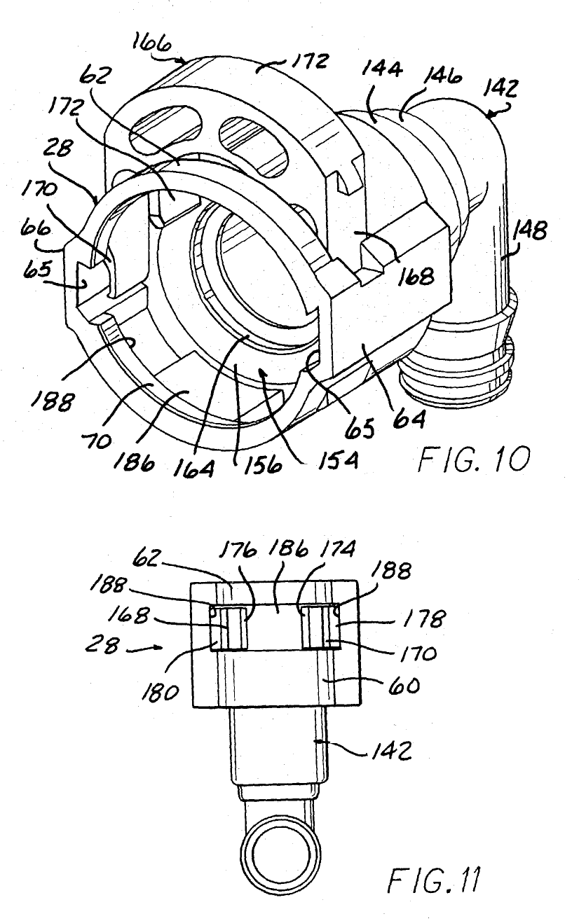

Internal grooves 65 are formed along an inner surface of each side leg 64 and 66. The grooves 65 continue through the ring members 60 and 62 as seen in FIG. 10.

According to a unique feature of the present invention, the first and second housings 26 and 28 are swivelably or rotatably connected. The rotatable connection of the first and second housings 26 and 28 is provided by the interaction of an annular recess 80 formed interiorly of the first ring member 60 in the second housing 28, the enlarged end flange 30 on the first housing 26 and an annular flange 82 on a top hat 84.

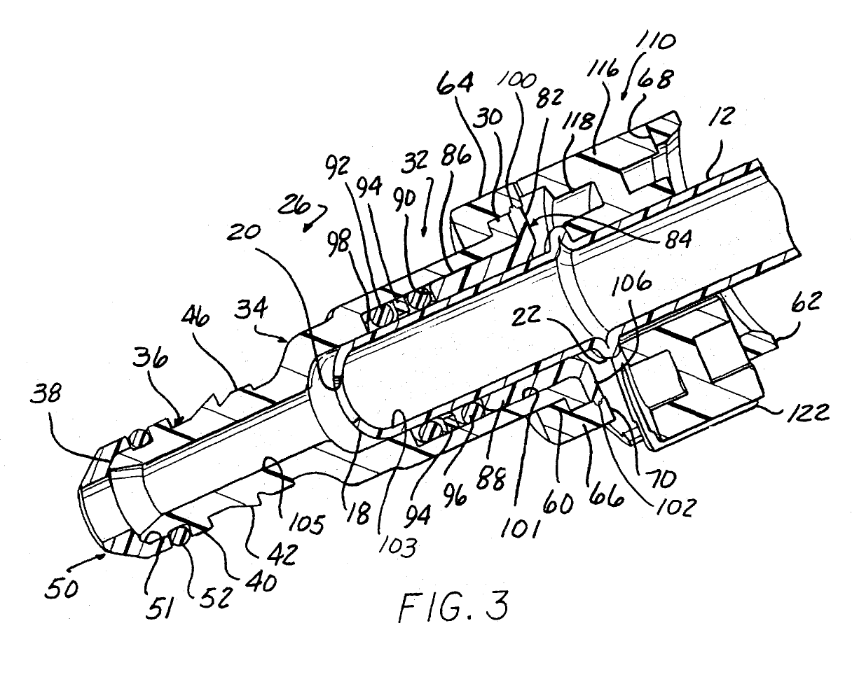

The top hat 84 is in the form of a one-piece member typically of a rigid plastic having an annular sleeve 86 projecting from the flange 82. A through bore 88 extends through the sleeve 86 and the flange 82 for accommodating the end portion of the first conduit 12 and for allowing the tip end 18 of the first conduit 12 to slide therethrough as shown in FIG. 3.

Referring briefly to FIG. 3, an end face 90 of the sleeve 86 on the top hat 84 holds a plurality of seal and spacer elements including one O-ring 92, an annular spacer 94 and another O-ring 96 in position adjacent a shoulder 98 formed between a first enlarged diameter bore portion and a second, smaller diameter bore portion 103 which form part of a stepped bore extending through the first housing 26. The stepped bore also includes a third yet smaller diameter bore 105 which extends through the stem 36 to the annular flange 38 at one end of the first housing 26.

As also shown in FIG. 3, the seal and spacer elements 92, 96 and 94 sealingly engage the outer surface of the first conduit 12 when the tip end 18 of the first conduit 12 is inserted through the top hat 84 and into the stepped bore in the first housing 26. The bore 88 formed through the sleeve 86 of the top hat 84 acts as a bearing surface for the end portion of the first conduit 12.

In one aspect of the present invention, the top hat 84 is lockingly held in position in the first housing 26 by means of a continuous or discontinuous radial projection 100 on the flange 82. The projection 100 snaps into an annular recess 102 to lock the top hat 84 in the second housing 28.

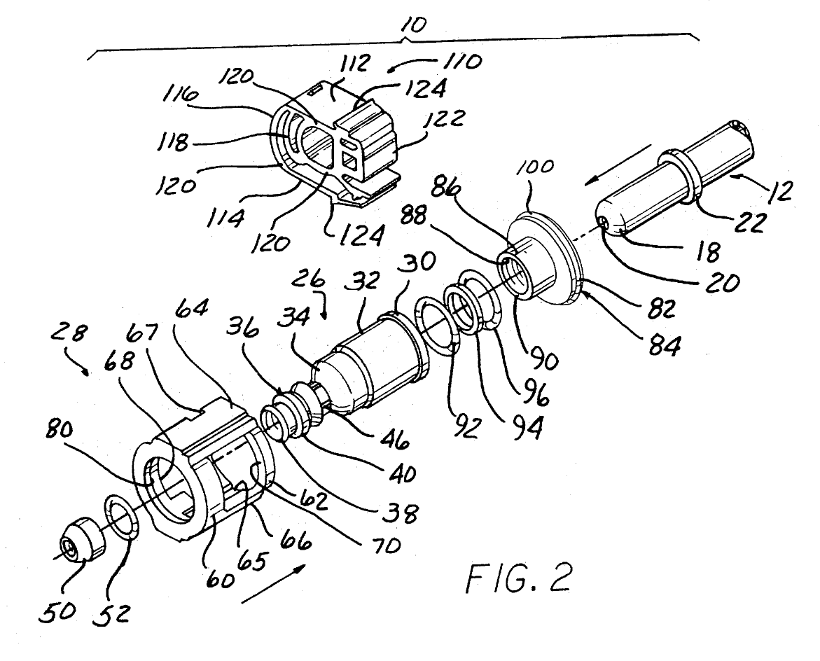

In this position, the flange 82 on the top hat 84 is disposed adjacent to, but spaced by a small clearance from the annular flange 30 on the first housing 26. As shown in FIGS. 2 and 3, the annular flange 30 on the first housing 26 is disposed in the annular recess 80 in the ring member 60 of the second housing 28. This enables the first and housing 26 and the second housing 28 to rotate relative to each other. As such, the second housing 28 may be rotated over a range of 360° about both of the first conduit 12 and the second housing 28 which has the second conduit 14 mounted thereto, for insertion or removal of a retainer 110 from the transverse apertures 68 and 70 in the second housing 28.

The retainer 110 is but one of a number of different shaped retainers, such as those shown in U.S. Pat. Nos. 5,542,716; 5,730,481; 5,782,502; 5,863,077; and 5,951,063, which can be used in the quick connector 10. The retainer 110 is adapted to be received in the transverse apertures 68 and 70 in the second housing 28 such that legs 112 and 114 of the retainer 110 will pass along either side of an exposed end portion of the first conduit 12 as the retainer 110 is inserted leg-first into the second housing 28. As illustrated in FIG. 2, the legs 112 and 114 of the retainer 110 extend in a first direction from opposite sides of an intermediate bridging portion or bight 116.

Each leg 112 and 114 includes an inner edge 118 which defines a “locking” surface adapted to axially oppose and preferably, axially engage one side of the upset bead or flange 22 of the first conduit 12 when the retainer 110 is fully inserted in the second housing 28. In this manner, the locking surface 118 on each retainer leg 112 and 1 14 serves to prevent axial displacement of the upset bead 22 from the axial bore of the second housing 28.

A cantilevered portion 120 on each leg 112 and 114 defines a radially-disposed, resiliently-yieldable surface which faces the other leg 114 or 112. These opposed radial surfaces 120 interferingly engage the exposed longitudinal end portion of the first conduit 12 upon full insertion of the retainer 110 into the second housing 28, thereby locking the retainer 110 to the first conduit 12.

A pair of outwardly extending projections or edges 124 are formed on the bottom portion of each leg 112 and 114. The projections 124 are devised to extend through the transverse aperture 70 and snap around the exterior surface of the ring member 60 and 62 of the second housing 28 to lock the retainer 110 in a fully inserted position in the second housing 28 as shown in FIG. 1. The projections 124 also engage the grooves 65 on the inside surface of the side legs 64 and 66 of the second housing 28 to temporarily lock the retainer 110 in a partially inserted, shipping position as shown in FIG. 10.

In assembling the connector 10, the first housing 26 is slidably inserted in a first direction through the bore 70 in the ring member 62 of the second housing 28 and through the bore 68 in ring member 60 until one edge of the flange 30 at the one of the first housing 26 engages a shoulder formed by the recess 80 in the ring member 60. The O-rings 92 and 96 and spacer 94 then inserted into the first bore 101 in the enlarged portion 32 of the first housing 26. The sleeve 86 of the top hat 84 is then inserted through the first bore portion 101 in the first housing 26 until the flange 82 is disposed adjacent to the flange 30 on the first housing 26. At this time, the projection 100 on the top hat 84 snaps into the projection 102 in the second housing 28 to lock the top hat 84 to the second housing 28.

The first conduit 12 can then be inserted through the bore 88 in the top hat 84, past the O-rings 92 and 96 and the spacer 94 and into the second bore portion 103 in the first housing 26 as shown in FIG. 3. The first conduit 12 is inserted into the first housing 26 until the annular flange 22 is disposed adjacent to the top hat 84 indicating a fully inserted position of the first conduit 12 in the first housing 26.

The retainer 110 is then pushed from the shipping position into the transverse apertures 68 and 70 in the second housing 28 to lock the first conduit 12 in the first housing 26; while still allowing independent rotation of the first and second housings 26 and 28 relative to each other.

Returning to FIG. 2, by example, one of the legs 112 of the retainer 116 extends to define a locking flap 122 at its free end. The locking flap 122 is preferably separated from the rest of the leg 112 by a living hinge or similar bridging member of reduced thickness. In this manner, the locking flap 122 is advantageously integrally formed with the retainer 110. It will be appreciated, however, that the use of separately formed, e.g., separated molded, flap member which is thereafter hingedly interconnected with one of the legs 112 or 114 either through use of integrally-formed hinge or a separate joining element, is also possible.

The locking flap 122 is permitted to pivot at the living hinge into interlocking engagement with the free end of the other leg 114, this being accomplished in the retainer 110 by means of interlocking engagement of a ramped locking projection on the inside of leg 114 with a complementary slot formed in the locking flap 122 adjacent the free end of the leg 112.

When the locking flap 122 is pivoted about axis into interlocking engagement with the other leg 114, as well as with its own leg 112 as described above, a surface on the locking flap 122 is brought into axial opposition with and, preferably, axially engages the upset bead 22 of the first conduit seated within the axial bore of the second housing 28. The locking flap 122 thus axially engages the upset bead 22 along a circumferential side edge thereof diametrically opposite to the circumferential side edge portion axially engaged by locking surface 118 on the bight 116. When added to the circumferential portions of the upset bead 22 axially engaged by the locking surface 118 on each leg 112 and 114, it will be appreciated that the quick connector 10 provides for substantially symmetrical axial engagement of the upset bead 22 while eliminating creation of deleterious bending moments which might cause leaking or structural failure of the resulting connection.

Further details concerning the construction of the retainer 110 can be had by referring to U.S. Pat. No. 5,782,502, the entire contents of which are incorporated herein by reference.

It will also be understood that the first and second housings 26 and 28 of the connector 10 of the present invention may be used with other types of radially displaceable retainers shown in U.S. Pat. Nos. 5,542,716 and 5,951,063.

Further, the rotatable connection between two portions of a quick connector can also be applied to quick connectors having axially displaceable retainers as shown in U.S. Pat. Nos. 5,542,712 and 5,456,600. In addition, the features of the present invention may also be applied so-called “squeeze-to-release” connectors shown by way of example in U.S. Pat. Nos. 5,873,610 and 5,568,946.

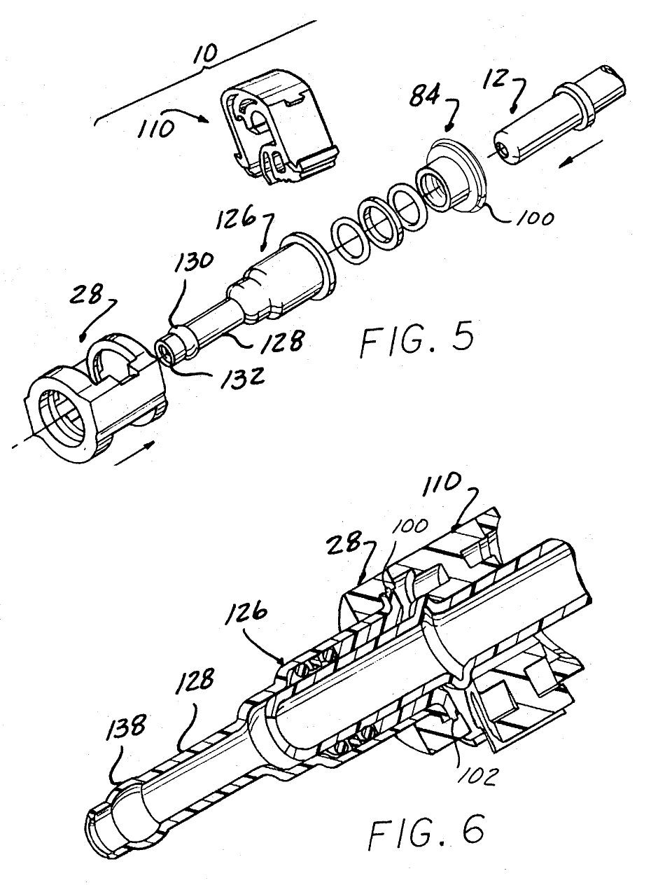

Referring now to FIGS. 4, 5, and 6, there is depicted a quick connector 10 similar to quick connector 10 which has a first housing 126 with a modified stem or end portion 128. The first housing 126 lends itself to formation from a metal material, such as stainless steel, etc. The stem 128 includes a generally rounded enlargement 130 spaced from a first end 132 which is adapted to engage one end of the second conduit 14, not shown. A cap, similar to cap 50, and including an O-ring 52, but without an annular interior recess 51, may also be employed with the first housing 126.

Otherwise, the construction, assembly and operation of the quick connector 10 shown in FIGS. 4-6 is identical to that described above and includes the second housing 28, and the top hat 84 which are adapted to receive the first conduit 12.

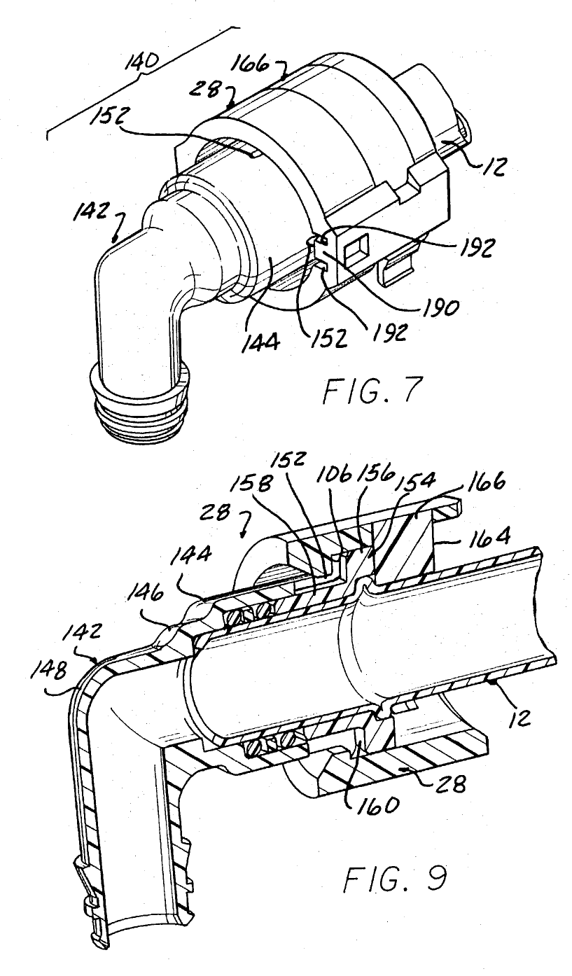

Referring now to FIGS. 7-10, there is depicted another aspect of a quick connector constructed according to the teachings of the present invention. The quick connector 140 shown in FIGS. 7-10 shares some of the same elements as the quick connector 10 described above and shown in FIGS. 1-6; but with several modifications which will be described in detail. Like elements of the quick connector 140 which are identical to like elements in the quick connector 10 will be described only briefly hereafter, reference being had to the prior description of such elements.

According to this aspect of the present invention, a first housing 142 has a stepped bore extending therethrough from an enlarged diameter bore portion in an enlarged end portion of the first housing 142, through a second smaller diameter bore portion in an intermediate portion 146 of the first housing 142, to a third yet smaller diameter end portion extending through a third portion 148 of the second housing 142. Although the first housing 142 is illustrated as being in the form of a 90° elbow, it will be understood that the first housing 142 may take any other shape, such as a conventional, axial in-line housing, similar to that shown above for the first housing 26, as well as a 45° elbow, etc. The first bore portion in the first end portion 144 of the first housing 142 receives the O-ring 92, the spacer 94 and the O-ring 96 described above.

The first housing 142 also includes an enlarged diameter end flange 150. At least one and preferably a plurality of circumferentially spaced slots 152 are formed in the first housing 142 through the flange 150 and partially along the length of the first end portion 144. The slots 152 allow radial movement of the flange 150 and the first end portion 144 of the first housing 142 as the first end portion 144 of the first housing 142 is slidably inserted into the second housing 28. Thus, the quick connector 140 of this aspect of the invention differs from the prior connector 10 in that it relies on a slide-in insertion of the first housing 142 into the second housing 28, opposite from the insertion direction of the first conduit 12 into the first housing 26 and a snap-in connection between the first and second housings 142 and 28 rather than a slide-in connection as for the connector 10.

During the connection of the first housing 142 and the second housing 28, the peripheral edge of the flange 150 will first engage the end portion of the bore in the ring member 60 of the second housing 28. This causes a radially inward compression of the flange 150 and the first end portion 144 of the first housing 142 until the flange 150 enters the recess 106 formed in the ring member 60. The flange 150 then snaps radially outward locking the first housing 142 in the second housing 28 and preventing radial disengagement in a direction opposite from the insertion direction.

It should be noted that the O-rings 92 and 96 and the spacer 94 can be preassembled in the first housing 142 prior to insertion of the first housing 142 into the second housing 28. It should also be seen that flange 150 is able to be rotated 360° within the recess 106 in the second housing 28.

A top hat 154 includes an enlarged end flange 156 and a smaller diameter annular sleeve 158 projecting therefrom. The outer diameter of the sleeve 158 is sized to slide within the first bore portion of the first end portion 144 of the first housing 142 into engagement with the O-ring 96 thereby holding the O-rings 92 and 96 and the spacer 94 in position within the first bore portion of the first housing 142 as shown in FIG. 9.

In this position, a shoulder 160 formed on the top hat 154 between the flange 156 and the sleeve 158 is disposed adjacent the edge surface of the flange 150 on the first housing 142, by a small clearance therebetween and rotatably traps the flange 150 between the shoulder 160 and the inner edge of the ring member 60 adjacent to the recess 106. The flange 156 of the top hat 154 is dimensioned to have an interference fit with the bore 106 formed in the ring member 60 of the second housing 28 as shown in FIG. 9. The interference fit can be provided by a suitably sized outer diameter of the flange 156 or by means of radially outward projecting, deformable, ribs 162 disposed circumferentially about the peripheral side edge of the flange 156. The ribs 162 engage the inner surface of the ring member 60 in the second housing 28 and deform to press fit the top hat 154 in a position in the second housing 28 spaced by a small clearance from the flange 150 of the first housing 142. Thus, the first housing 142 is trapped within the second housing 28 by the interaction of the top hat 154 and the recess 106 in the second housing 28; yet is able to rotate though 360°. This allows the transverse apertures 68 and 70 in the second housing 28 to be rotated to any position to allow easy access for insertion of or removal of the retainer 166 therefrom.

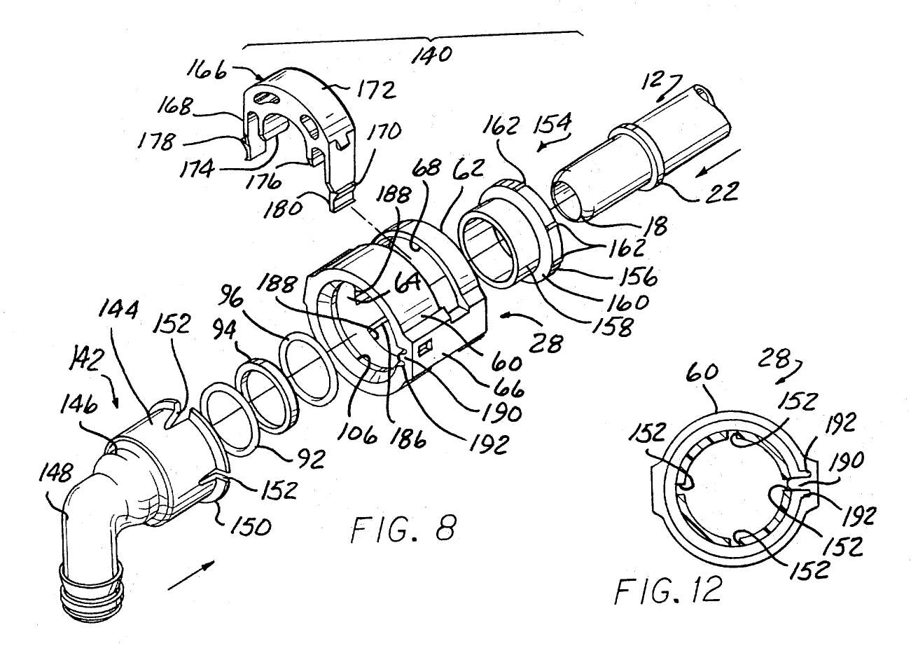

The features of the retainer 166 and the top hat 154 described above and shown in FIG. 8 can also be applied to the quick connector 10 shown in FIGS. 1-6 in order to seat the flange 22 on the first conduit 12 in the top hat 154.

It should also be noted in FIGS. 9 and 10 that an end portion of the flange 156 of the top hat 154 is provided with an annular recess 164. The outer diameter and the depth of the recess 164 are sized to receive the annular flange 22 on the first conduit 12 at a fully inserted position of the first conduit 12 in the joined first and second housings 142 and 28 as shown in FIGS. 7 and 9.

The retainer 166 is similar to the retainer shown in U.S. Pat. No. 5,730,481 in that it includes a pair of legs 168 and 170 which depend from a central bight portion 172. Inwardly extending projections 174 and 176 have free ends movably spaced from the adjacent legs 168 and 170 and are dimensioned to slidingly engage and fit around the cylindrical portion of the first conduit 12 only when the first conduit 12 is fully inserted into the second housing 28. Outwardly extending projections 178 and 180 are formed on the lower portion of each leg 168 and 170 and are devised for engaging an edge of the grooves 65 in the side legs 64 and 66 of the second housing 28 in a partially inserted, shipping position shown in greater detail in FIG. 10, or a lower edge of the side legs 64 and 66 in the fully inserted position thereby locking the first conduit 12 in the joined first and second housings 142 and 28.

In this aspect of the invention, the retainer 166 does not have an undercut forming a surface which is adapted to engage the side surface of the enlarged flange 22 on the first conduit 12 when the first conduit 12 is fully inserted into the first and second housings 142 and 28. Rather, the interior portions of the retainer 166 are substantially flush with the side edges of the legs 168 and 170. However, it will be understood that the projections 174 and 176 will still resist full insertion of the retainer 166 into the second housing 28 if the first conduit 12 is not fully inserted into the first housing 142 since the enlarged flange 22 will be in an interference position with the projections 174 and 176.

Further, the use of the recess 164 in the top hat 154 is applicable to other quick connectors, such as those in the previously listed patents, wherein the connector includes only one non-rotatable housing.

Several unique aspects of the connector 140 will now be described. As shown in FIGS. 8 and 11, a web or flange 186 is formed in the first housing 26 between the first and second ring members 60 and 62. The flange 186 is preferably disposed in the transverse opening 70. The flange 186 divides the transverse opening 70 into two small slot-like apertures denoted by reference number 188. Each aperture 188 receives the lower end portion of the side legs 168 and 170 of the retainer 166, but will prevent a large amount of radially inward flexing of the lower end portions of the side legs 168 and 170 during removal of the retainer 166 from the second housing 28 which could cause breakage of the legs 168 and 170.

The web 186 can also be employed in other connectors, such as those describe in the above-listed patents.

FIG. 10 also shows the longitudinally extending interior grooves 65 formed in each of the side legs 64 and 66 of the second housing 28. The grooves 65 receive the projections 178 and 180 on the side legs 166 and 170 of the retainer 166 in a snap-in connection to hold the retainer 166 in the partially inserted shipping position shown in FIG. 10.

The retainer 166 will remain in this shipping position that the retainer 166 will remain in during insertion of the first conduit 12 into the joined first and second housings 142 and 28. Only after the first conduit 12 has been fully inserted into the first housing 142 will the retainer 166 be able to be fully inserted through the transverse aperture 70 in the second housing 28 as described above.

Finally, as shown in FIGS. 7 and 12, the connector 140 is provided with a unique indexing feature in which a radially inward extending projection 190 is formed adjacent one end of the second housing 28. The projection 190 has undercut side edges 192 which allow flexure of the projection 190.

The projection 190 is positioned to engage any of the slots 152 in the first housing 142 when the first housing 142 is rotatably mounted in the second housing 28 as described above. In this manner, one of the first housing 142 and the second housing 28 is rotatable relative to the other until the projection 190 engages one of the slots 152. Continued rotation of either the first housing 142 or the second housing 28 will cause the projection 190 to flex radially outward thereby disengaging from one of the slots 152 and allowing the projection 192 to slide along the exterior surface of the first end portion 144 of the first housing 142 until the projection 190 reaches and snaps into the next circumferentially adjacent slot 152. This provides a tactile feel to the installer to fix the relative angular positions of the first and second housings 142 and 28.

The slots 152 and the projection 190 could be reversed on the first and second housings 142 and 28 with the same effect.

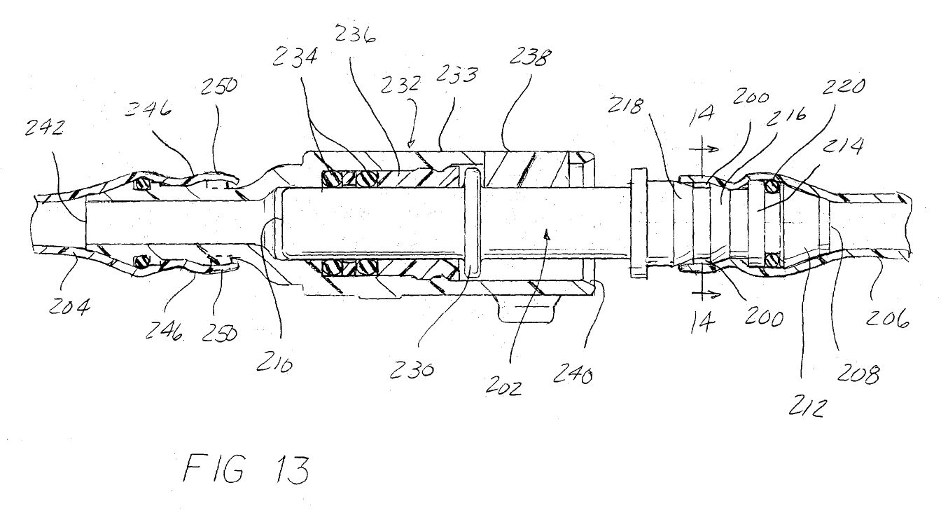

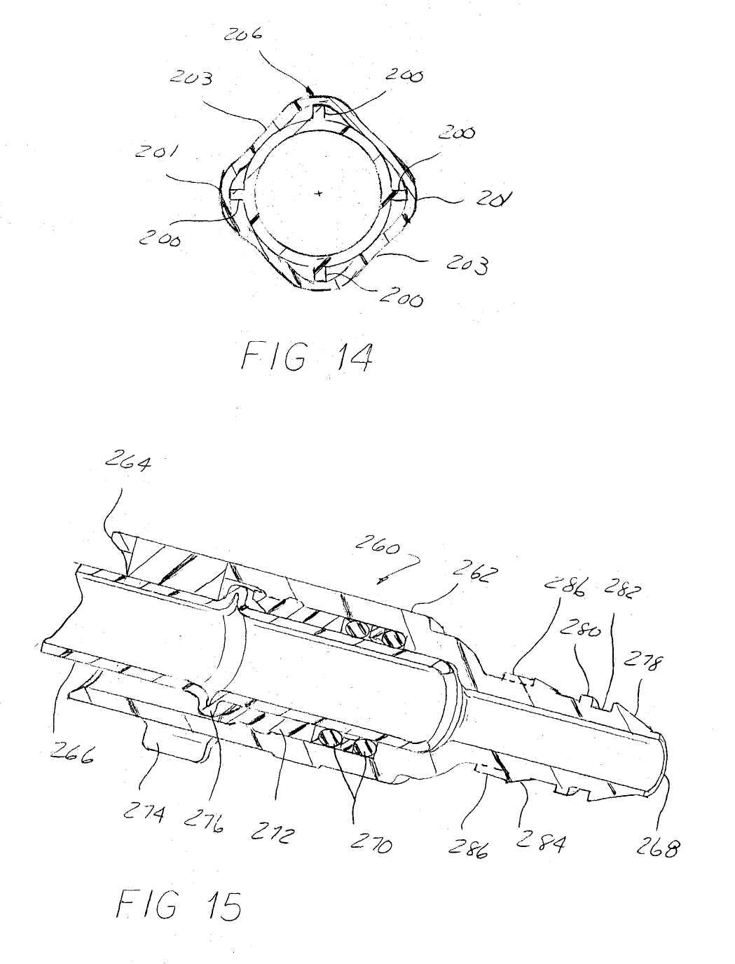

Referring now to FIGS. 13 and 14, there is depicted another aspect of the present invention wherein non-rotation ribs 200, including at least one or optionally a plurality of non-rotation ribs 200 are carried on at least one end, and possibly both ends, of a fluid conduit or tube adaptor 202. The adaptor 202 is configured for fluidically coupling two separate conduits or tubes 204 and 206.

The adaptor 202 is in the form of a hollow body having a first end 208 and an opposed second end 210. The first end 208 includes an annular, conical-shaped end flange 212 and at least one and, preferably, a plurality of axially spaced barbs or projections 214, 216 and 218. The barbs 216 and 218, by example only, also have a conical shape. The projection 214 defines an annular recess from one end of the end flange 212 for receiving a seal member, such as an O-ring 220.

The ribs 200 extend axially along the length of the adaptor 202 from the barb 216. The ribs 200 have a radially extending, non-annular shape so as to define discrete elements about the circumference of the adaptor 202. The portion of the conduit 206 insert over the ribs 200 defines annular depressions which allow the end of the conduit 206 to form a non-annular shape with raised portions or ridges 201 over the ribs 200 and depressed portions or recesses 203 between the ribs 200. The alternating ridges 201 and recesses 203 provide a structure which resists rotation of the conduit 206 with respect to the adaptor 202.

The second end 210 of the adaptor 202 may also have the alternating, axially spaced barbed configuration formed on the first end 208. However, by example only, the adaptor 202 in FIGS. 13 and 14 is depicted as having a generally constant diameter portion extending from the second end 210 to an annular, radially enlarged flange or bead 230. The flange 230 is adapted for mating with a fluid quick connector 232 having a one or two-piece construction, such a two piece housing construction described above and shown in FIGS. 1-3. In either configuration, the quick connector 232 includes an internal bore which receives seal elements 234 and a rigid top hat 236. A retainer 238 is mountable in the quick connector housing 233 for locking the flange 230 of the adaptor 202 in the housing 233. Although the retainer 238 is shown as being a transversely mountable retainer, similar to the retainer 110 shown FIG. 2 or the retainer 166 shown in FIG. 8, an axially mounted retainer insertable through one end of the fluid quick connector 232 may also be employed.

With continued reference to FIGS. 13 and 14, the housing 233 of the quick connector 232 has a second end 242 opposed to a first end 240 which is adapted for receiving the second end 210 of the adaptor 202. The housing 233 has an axial spaced arrangement similar to the barbs or projections 212, 214, 216 and 218 on the first end 208 of the adaptor 202. By example only, one of the barbs or projections 246 is adjacent to at least one or possibly a plurality of non-annular, axially and radially extending ribs 250 which are similar to the ribs 200. The ribs 250 engage one end of the conduit 204 and form the circumferentially alternating ridges 201 and recesses 203 in the conduit 204 in the same manner as the ribs 200 for the conduit 206 to resist rotation of the conduit 204 relative to the housing 233 of the quick connect 232.

The ribs of the present invention may also be employed on a one-piece fluid quick connector 260 shown in FIG. 15. The quick connector 260 has a number of common features with the quick connector 232 of FIGS. 13 and 14 in that the quick connector 260 includes a housing 262 with an internal bore extending from a first end 264 configured for receiving an endform 266 therethrough and an opposed second end 268. Seal elements 270 and a top hat 272 are mounted in the bore. A retainer 274 releasably locks an annular flange or bead 276 on the endform 266 in the housing 262.

The second end 268 of the housing 262 is formed with an axially extending barb configuration including a first conical barb 278, an annular projection 280, and a recess 282 between the barb 278 and the projection 280 for receiving a seal member, such as an O-ring, not shown. Another barb 284 is axially spaced from the projection 280. At least one or optionally a plurality of circumferentially spaced, axially and radially extending, non-annular ribs 286 are formed on the housing 262 and extend axially from one end of the barb 284. The ribs 286 function in the same manner as the ribs 200 and 250 for the adaptor 202 shown in FIGS. 13 and 14 in that the ribs 286 cause the end of a flexible conduit mounted thereover to assume a circumferentially alternating series of ridges and recesses which resist rotation of the conduit relative 262.

In summary, there has been disclosed a unique fluid quick connector having one or a plurality of ribs or projections formed on the tip end which are forcibly engagable with the inner surface of the flexible conduit mounted thereover to prevent rotation between the tube and the housing.

What is claimed is:

1. A fluid connector comprising:
a body having a bore extending between first and second ends;
at least one barb formed on at least one of the first and second ends of the body, the barb adapted to expand one end of a flexible conduit as the flexible conduit is urged over the barb; and
at least one non-annular, axially and radially extending rotating resisting rib carried on the body adjacent to the at least one barb, the at least one rib resisting rotation of a flexible conduit urged over the first end of the body relative to the body.

2. The fluid connector of claim 1 further comprising:
a plurality of barbs axially spaced from one of the first and second ends of the body, the at least one rib disposed adjacent to one of the plurality of barbs.

3. The fluid connector of claim 1 comprising:
one end form having an external flange proximate to a first end;
a retainer mountable in the bore of the body to prevent axial displacement of the end form from the first end of the body.

4. A fluid connector for joining first and second conduits in fluid flow communication, the first conduit having an enlarged flange spaced from a first end, the quick connector comprising:
a first housing having a through bore with a first bore portion adapted for receiving a first end of a first conduit;
a second housing rotatably and non-axially displaceably connected to the first housing, the second housing having a through bore axially alignable with the first bore portion of the first housing for receiving the first conduit therethrough, a second conduit adapted to be mounted on the first housing;
a retainer mountable in the second housing for lockingly coupling the first conduit to the first housing;
the first housing having a second end opposing a first end;
the second conduit adapted to be mountable over the second end of the first housing; and
at least one axial, non-annular, axially and radially outward extending rib carried on the second end of the first housing and adapted to be engageable with the inner surface of the second conduit to rotatably resist rotation of the second conduit relative to the first housing.

5. The fluid connector of claim 4 wherein:
the at least one rib is one of a plurality of circumferentially spaced, radially outward ribs on the second end of the first housing.
